(19) United States
(12) Patent Application Publication
(10) Pub. No.: US 2007/0132660 A1
(43) Pub. Date: Jun. 14, 2007

(54) System and method for media distribution and display

(76) Inventor: William Nuttall, North Vancouver (CA)

Correspondence Address: KNOBBE MARTENS OLSON & BEAR LLP, 2040 MAIN STREET, FOURTEENTH FLOOR, IRVINE, CA, 92614, US

(21) Appl. No.: 11/472,803

(22) Filed: Jun. 21, 2006

Related U.S. Application Data
(60) Provisional application No. 60/692,851, filed on Jun. 22, 2005.

(51) Int. Cl. G09G 5/00

(52) U.S. Cl. 345/2.3; 345/2.2

(57) ABSTRACT

A communications network that controls gasoline pumps having multimedia players. The communication network comprises one or more communication networks including satellite, terrestrial, and wireless. A data center transmits media to the gasoline pumps and receives feedback from the gasoline pumps. The operation of the system includes broadcasting media, playing media, monitoring status, and reporting activity and information about the multimedia players. The communication system facilitates these operations and provides data security in the gas station environment.

### CROSS REFERENCE TO RELATED APPLICATIONS

This application claims priority under 35 U.S.C. Section 119(e) to U.S. Provisional Application 60/692,851, filed on Jun. 22, 2005.

### BACKGROUND OF THE INVENTION

1. Field of the Invention

This invention relates to a system and method for distributing media for display by multiple gas pumps.

2. Description of the Related Art

Generally, the functions of gas pumps installed at gas stations are still quite simple, and involve only refilling and gasoline metering functions. When refilling the tank, drivers and passengers typically have nothing to do but wait for the completion of tank refilling.

U.S. Pat. No. 6,601,039 describes a gas pump that accesses the Internet for controlling and effecting electronic commerce and that can also display advertising messages and perform commercial transactions during the refilling process.

Although this patent describes one possible approach to distributing multimedia to a gas pump, improvements in this system are desirable.

### SUMMARY OF THE INVENTION

One embodiment is a system for distributing advertising to a plurality of gas pumps via a combination of a wired link and a wireless link, the system comprises a computer being configured to store and transmit data over a first network via a wire line, a wireless access point remotely located from said computer and configured to receive the transmitted data over the wire line and broadcast the received data over a second network via a wireless link, and a plurality of gas pumps, each having a receiver for receiving the data transmitted by the wireless access point and being configured to display data associate with the received data.

Another embodiment is a method of distributing advertising to a plurality of gas pumps that comprises selecting an advertisement at a computer, transmitting the selected advertisement to a wireless access point located remotely from the computer and over a first network, receiving the transmitted advertisement at the wireless access point and over the first network, and transmitting the received advertisement to a plurality of gas pumps over a second network. The method further comprises storing the transmitted advertisement at each of the plurality of gas pumps and displaying the stored advertisement on a viewable screen of at least one of the plurality of gas pumps.

### BRIEF DESCRIPTION OF THE DRAWINGS

FIG. 1 is a block diagram of a system for assembling and distributing media to stations in one embodiment of the invention;

FIG. 2 is a block diagram of a system for assembling and distributing media to stations showing one embodiment of the components that are located at the data center and the customer from FIG. 1;

FIG. 3 is a block diagram illustrating an exemplary combination of communication protocols that are implemented by the system of FIG. 1 in one embodiment of the invention;

FIG. 4 is a block diagram of an embodiment of a system for assembling and distributing media to stations through two wide area networks (WAN);

FIG. 5 is a block diagram of a pump island wirelessly linked to a convenience store and configured to receive and display media and transmit related data in one embodiment of the invention;

FIG. 6 is a flow chart of one method for providing media security which may be performed by the system.

### DETAILED DESCRIPTION OF THE PREFERRED EMBODIMENT

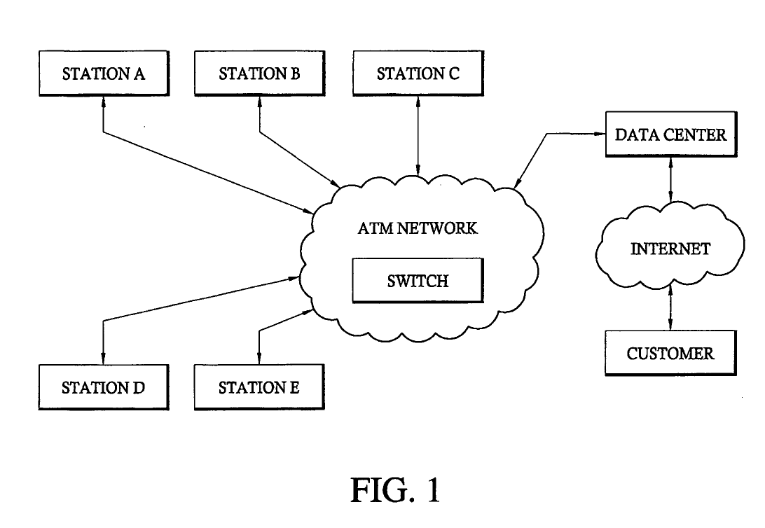

FIG. 1 illustrates a block diagram of one system embodiment for generating and distributing media or data files for a pump display. The system 100 distributes advertising to a plurality of gas pumps via a combination of a wired link and a wireless link. In certain embodiments, the system comprises one or more computers configured to store, receive, and transmit data over a first network via at least one wired link. A wireless access point is remotely located from the media source which receives the transmitted data over the wired link and broadcasts the received data over a second network via a wireless link. The system further comprises a plurality of gas pumps having receivers for receiving the data transmitted by the wireless access point and being configured to display data associated with the received data.

The system 100 may be used to distribute, manage, monitor and display data files on the form of media presentations in gas station environments. The data files may serve a promotional, operational, entertainment, or educational function. By using data files, the present embodiment can leverage the strengths of network distribution including rapid updating, improved process management, dynamic integration of multiple data file sources and robust control over remote playback at the gas station. Accordingly, the system 100 may be used to generate revenue and/or increase consumer traffic.

Promotional applications may include at pump marketing efforts to motivate desired consumer behavior by increasing consumer awareness. For example, media presentations may highlight product availability or specific gas station incentives to motivate product purchase. These products may include offers for a car wash, food, automotive service, vendors offering products or services nearby or along the consumers chosen route. Operational functions include features that are central to the functioning of the gas pump, for example selecting an octane level and payment method. Entertainment functions may include providing portions of a television show to consumers or gas station personnel. Educational functions may include weather and traffic reports. Regardless of the content, the data file or media is assembled, transmitted, received, and played at the plurality of gas pumps using the software and hardware infrastructure.

It will be understood that the data file may be passive or interactive. The play back of the data file may respond to direct consumer input. For example, a promotional application for a car wash can be presented on the display screen that changes the type of information displayed in response to consumer selections.

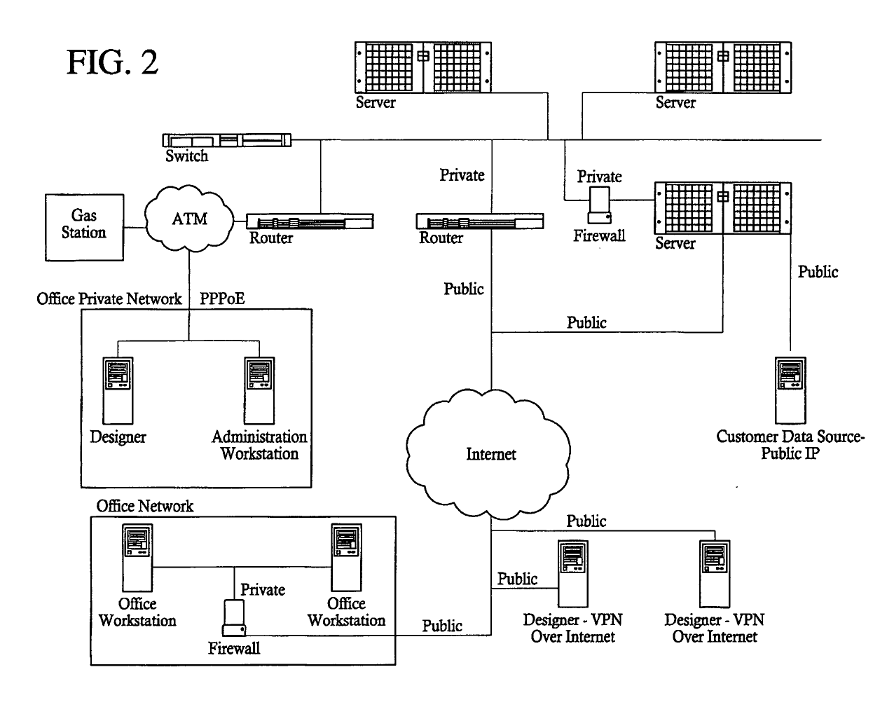

As shown in FIG. 1, system 100 includes a data center 102 for assembling at a central location, data files or media for the plurality of stations 104(a)-(e). A detailed operational explanation of the data center 102 is described in connection with FIG. 2. Developed data files are stored in a database at the data center 102 and staged for distribution through a distribution server. Data files, related information, and security codes are distributed through a wide area network (WAN) 110 to a plurality of gas pumps at the stations 104(a)-(e). Each of the plurality of gas pumps includes a multimedia player. Information about the operation of the player may be transmitted back to the distribution server at the data center 102 for analysis.

It has been found that it is advantageous for the WAN 110 to be a closed loop or two-way network. The network may be wired, wireless, or a composite of wired and wireless networks. In certain embodiments, the network is a composite of terrestrial and wireless communication layers for purposes of narrowcasting specifically targeted data files to players in specific locations. The wireless communication layers may include satellite transmission. In one embodiment, broadcasting is implemented over a terrestrial land-based network. The system and communication network together provide a comprehensive design for the broadcasting of media files to convenience stores and gas stations with multimedia players at the gas pumps.

The gas pump comprises many conventional gas pump elements along with the multimedia player. The multimedia player includes a video display, a sound system, and a controller. The video display can be CRT electronic displays, plasma display (PDP), LED display, normal LCD display (LCD), or high-brightness LCD display (VHB LCD). When the CRT electronic displays, plasma displays (PDP), LED displays, and normal LCD displays are put outdoors, the images shown are not clear in the direct sunshine and the visual angles are narrow. When the high-brightness LCD displays (VHB LCD) are used outdoors, the images are very clear with bright colors and wide visual angles, so the high-brightness LCD displays have been found advantageous in many embodiments.

The sound system includes speakers for providing sound to the customer. The display and audio system may be configured such that when someone refills the tank, the gas pump starts playing advertisements at the point when a new user takes up the pump nozzle until the current cycle of refilling is ended and the pump nozzle is again replaced. The gas pump can also obtain information about the operation of the media player and transmit that information to the data center 102. This information may include playing time and playing frequency of a data file, the total play time and frequency of a data file at different pumps at different places, and when one or more data files are downloaded or updated.

The multimedia player displays video while the sound system plays, for example, dynamic data files, news, or other information during the refilling process. In operation, a motorist takes up a pump nozzle which typically trips a sensor switch indicating that the nozzle has been removed from its storage bay. The motorist then turns on the pump nozzle, tripping another signal switch and initiating gasoline flow. The gas pump receives the signals and drives the pump, pumping gas to the nozzle and into the vehicle. The gas pump calculates the amounts for display on a gallon/dollar display. When the volume of the fuel reaches the set value/volume or a full tank is sensed, the pump motor shuts down, the refilling stops, and the user places the nozzle back in the storage bay.

The data file is generated at the data center 102 or received from one or more customers 106. The data center may receive the media from the customer 106 via a network, such as the Internet 108. Of course other networks, public and private, may be used instead of the Internet as well as wireless networks between the data center 102 and the customer 106.

In certain embodiments, the system 100 in combination with the communication network(s) forms a private network. The private network may be IP-based. In certain other embodiments, a combination of technologies using satellite and point-to-point communications is used. By using combinations of technologies, locations that are not accessible to private IP networks because of complexities in the topology of the land-based communications facilities may be reached.

One or more data center operators may modify, format, and digitize the received data file or media before the data file is distributed to the stations 104(a)-(e). For example, the aspect ratio of a data file designed for broadcast on television may be cropped and scaled so as to improve its display by the gas pump. In some embodiments display information, for example brightness, contrast and color tone, associated with the data file received from the customer, is modified before the data file is distributed to the stations 104. In some embodiments, instructions to modify the data file are transmitted with the data file and implemented at the gas pumps. These modifications may comprise changing the language, scaling, adding subtitles, and the like that are associated with the data files. Such changes may be advantageous for displays experiencing adverse weather or lighting conditions and well as displays located in specific ethnic regions. For example, the brightness may be increased during daylight hours and reduced during nighttime hours.

Continuing with the description of FIG. 1, data files assembled at the data center 102 may include full motion digital video, still images, computer-generated animation, text and/or audio. The data file is assembled into a complete digital multimedia presentation and stored in the server at the data center 102. One or more complete digital multimedia presentations may be combined into a compilation of one or more data files for transmission to the stations. Data center operators can schedule and transmit the data files to the multimedia players.

The data center 102 enables an operator to collect data from the customer 106, receive feedback from one or more multimedia players, and access the data files in the database in order to assemble data file compilations for each station 104 or for one or more individual gas pumps. The data file displayed at the gas pump may be determined in part by specific requests or data from employees and customers of the convenience store, which may be entered at the gas pump. These requests are received and processed through the data center 102. Data center 102 operators may utilize the requests to modify the data file and reissue commands to distribute the modified data file.

Data files or compilations of data files are distributed from the data center 102, to the plurality of stations 104, using a wide area network (WAN) 110, such as an ATM network or the like. Thus, the blocks of FIG. 1 to the right of WAN 110 are at the data center 102 and customer 106 location, whereas the blocks to the left of WAN 110 are individual stations 104 having one ore more gas pumps. It will be understood that the data center 102 may include a plurality of discrete sites which act as distribution points for the data center 102. Similarly, the various components for the gas stations need not be physically located at the gas pumps, except for the display screens of the multimedia players. Rather, these components may be included at another location associated with the gas pump. These other locations may include the convenience store.

At the gas pumps, the data files, information associated with the data files, and security codes may be received, disassembled and stored in the multimedia players. Customer instructions or other on-site data such as point-of-sale information can be integrated into the data file on the multimedia players. Relevant data about the media and the state of the multimedia players may be recorded and transmitted to the data center 102. An operator at the data center 102 can view this data.

After a predetermined date, the data file may be retired and replaced by another data file which is delivered to the multimedia player as described above. Alternatively, a site-specific default advertisement, which is always present on each multimedia player may be used. The default advertisement may be designed to be appropriate for on-site display at any time for a given customer 106 or displayed at a specific or periodic time.

The system 100 is preferably designed to allow most data files to play without any action on the part of the convenience store or pump operators. However, there may be some functions for which it is useful to provide control and management tools to the convenience store manager, such as selecting from among multiple implementations of a particular data file, or setting the store hours or schedule for a particular convenience store. This on-site customization may be obtained using the display of the multimedia player.

FIG. 2 is a block diagram of a system 200 for assembling and distributing advertising and media in the form of data files to stations 104 showing one embodiment of the components of the data center 102 from FIG. 1. As shown in FIG. 2, the data center 102 comprises control and monitoring software which may be accessed by system operators at the office network 204 and the office private network 206 to manage, customize, and compile data files, manage distribution of the data files, and track and analyze history and feedback from the plurality of gas stations 104.

In certain embodiments, the data center 102 comprises one or more computers, routers, firewalls, servers, and network switches connected directly or indirectly through one or more networks. For illustration purposes, in FIG. 2 one or more of these components are co-located as parts of the office network 204 and of the private network 206. In certain embodiments, more or less of the components are collocated at fewer offices or are distributed among additional offices. Further, the system 200 may include more or less components depending on the desired implementation without deviating from the scope of the invention.

Data files and compilations of data files are generated by first developing or assembling media intended for display at multiple gas stations 104. For example, when the multimedia player displays ads for rooms for a motel chain, a data file in the form of an advertisement includes a list of room rates for the motels. In certain embodiments, these data files are developed by the customer 106 or other creative professionals at advertising agencies. The developed data files are subsequently stored on server 202 at the data center 102. The data files await assembly and release for distribution to the gas stations 104.

In certain embodiments, operators of the office network 204 customize and compile the data files for the individual multimedia players or gas stations 104. For example, customization may take place by generating for each gas station 104 or multimedia player, gas station site-specific information comprising selected rooms offered by a motel chain, the associated prices for the rooms, and motel specific data files, to form a customized data file for each motel site including room prices offered at the nearest motel site, the associated prices, and data files concerning the rooms.

It will be understood that customization may take place independent of gas station 104 input. However, instructions or data gathered from the gas station site may influence the advertisement customization. Advertisements are preferably customized using the office network 204 and server 202 at the data center 102. The data in the server 202 may be obtained by operators of the private network 206 at the data center 102.

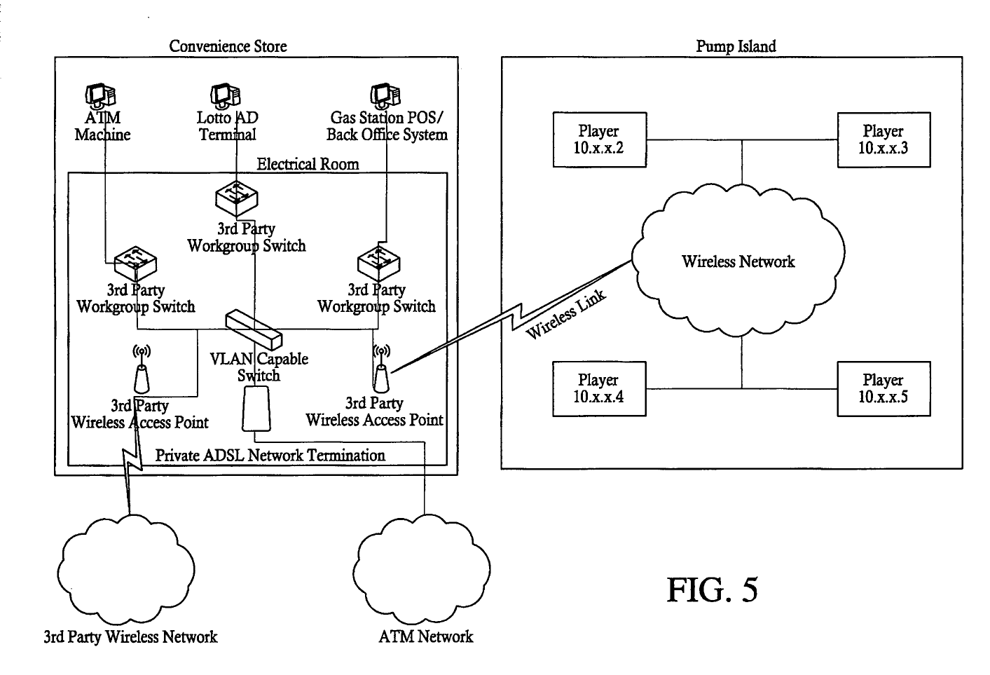

In addition to customization, play windows, for example days and times can be assigned to the data files and will be described in detail with reference to FIG. 5. This information is transmitted to the multimedia player along with the data file. Additionally, security codes may also be transmitted to the multimedia players. The inclusion of this information allows the customer 106 to request certain times and dates to display their data file as well as the frequency at which they are displayed.

In certain embodiments, the operators of the office network 204 create a default data file for display during periods that there is limited customer 106 interest, for example 2 am-5 am. The default advertisement may include generic material for the gas station which is displayed in the absence of a customer requested data file.

Further customization may be applied to the data file. In particular, the store manager may provide further customization of the media presentation. For example, the playing hours may be modified and prices may be changed. If alternative data files are stored at the gas station, one may be selected for presentation at the gas station. It will be understood that central customization and on-site customization may be used to optimize overall network resources and efficiency. It will also be understood that on-site customization may occur real time or dynamically as the media program is played by the multimedia player.

Operators of the office network 204 assemble and release the data files to a distribution server 208. The data files and compilations of data files are queued for distribution to the individual multimedia players via the distribution server 208 and ATM or wide area network 110 of FIG. 1. One or more ISDN/FR/ATM routers may be used to route messages to one or more wide area networks 110. Customer routers may be used to interface with the data center 102.

The server 208 includes software for preparing, scheduling, and broadcasting data files and other information to the remote multimedia players at the gas stations 104. The broadcast information may identify the instructions of what to broadcast and where to broadcast, details about the transmission size and speed, and the number of retries that is to be transmitted after the initial broadcast.

In certain embodiments, the data center and player control software located at the multimedia players encode the player information as a name (i.e. hostname or player name) instead of specific detailed addressing information.

The office private network 206 accesses the distribution server 208 and identifies the data files which are available for distribution. In order to distribute a compilation of data files, an operator at the office private network 206 selects one or more data files from the database 202, specifies destination sites, hostnames, or player names and schedules the compilations play window. The compilations related information is stored in the distribution server 208. Compilations are queued for distribution to the players using a media distribution program. The distribution server 208 transmits the compilations, any information associated with the compilations or multimedia players, and security codes, to the multimedia players. Preferably, the information includes a play list identifying the prescribed operation of the multimedia player on conjunction with the data files.

In certain embodiments, the server 208 comprises data reporting software. The data reporting software receives log information from the gas stations 104 and generates reports on the information collected and logged at the multimedia players. The log information may include, for example, media clip activity and pump handle activity. Operators of the office private network 206 can display the logged information about individual multimedia players, pump handles, data files, and usage. For example, a particular data file may have several versions. An operator of the office private network 206 or gas station 104 may select one of these several versions for broadcasting to the media players. The actual data file which is selected at any given multimedia player can be monitored from the data center 102. Customer input data to the multimedia player can also be analyzed to monitor advertisement effectiveness with respect to sales.

The input data may also be provided to the operators of the office network 204 and the customer 106 to generate new data files if a current advertisement is not effective. It will be understood that each individual pump handle use may be associated with actual media played on the multimedia player during that use. In certain embodiments, the data reporting software provides comprehensive usage reports based on the associations of one or more raw data elements for the multimedia players. These raw data elements may include accounting of time duration as well as comprehensive reporting by location, groupings, or totals. Thus, information such as multimedia player operating status and the currently or most recently displayed data file can be provided to the data center 102.

In certain embodiments, the server 208 comprises broadcast control system software which allows the data center 102 to change, re-sequence, refresh, delete, or manipulate the data files at the multimedia players. The broadcast control system software monitors broadcast delivery of media content and play list files to the multimedia players and broadcasts files using multicast and unicast protocols. Broadcast grouping allows “one-button” style broadcasting of all data to the multimedia players as well as scheduling of broadcast tasks to assist in automation of dynamic content delivery. The multimedia players may be grouped by, for example, location and/or time zone.

The broadcast control system software integrates with the multimedia player software to confirm content delivery. For example, the multimedia players may be programmed separately to play different media or have different personalities and to play the data files according to schedules and sequence instructions received from the data center 102.

In certain embodiments, the broadcast control system comprises a “pre-broadcasting” feature. The pre-broadcasting feature allows the customer 106 to review and approve the information intended for broadcast to the multimedia players. The customer accesses and signifies their approval for the broadcast of their data file prior to its broadcast. Once an authorized customer reviews and signifies their approval, the data center 102 is notified by, for example, an e-mail message. Logs of such activities may be captured by the data center 102.

In certain embodiments, the server 208 includes health watchdog system software. The health watchdog system software may continually or periodically contact each of the multimedia players at the gas stations 104 to determine each player's operational status, health, and activities. In the event that a player does not respond within a predetermined period, an error condition is reported to the operator of the office private network 206. This health watchdog system software can be customized as to sequence retries and reporting status so as to ensure that the players at the gas pumps are operational for receiving and reacting to operator queries. Each player's operational status, health, and activities may be logged for transmission back to the data center 102 on a scheduled or periodic basis.

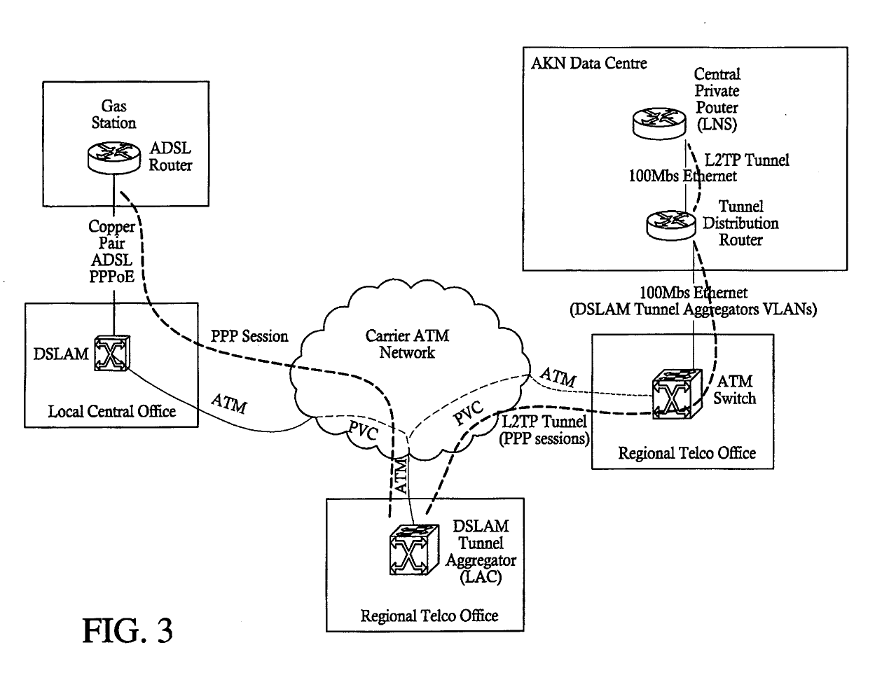

FIG. 3 is a block diagram illustrating an exemplary combination of communication protocols that are implemented by the system of FIG. 1 in one embodiment. The communication protocols may include, for example, Ethernet, ATM, DSL, and the like. As shown in FIG. 3, the data center 102 communicates with the gas station 104 via regional telco offices 302, 304, and local central office 306. The data center 102, however, may communicate with the gas station 104 via a different communication path than illustrated in FIG. 3. The data center 102 may perform data transmissions and communications with the gas station at different places by means of wireless networks (such as CDMA, GPRS, satellites, 802.11 wireless LAN) or wired networks (ISDN, ADSL, ATM, DDN dedicated lines), or a combination of these methods. It has been found advantageous to implement the distribution of the data files as a standard Ethernet protocol to an ATM switch located at the regional telco office 302.

The data center 102 may employ distinct output ports. Each output port transmits a data file or a compilation of data files, information associated with the data file, and security codes along with a list of recipient hosts or player names. Each multimedia player is assigned an IP address (static or dynamic) for communication to/from the data center 102. The regional telco office 302 receives the data files and then appropriately distributes the data file based on the associated list of recipient hosts or player names. The data file or compilation of data files is forwarded through the carrier ATM network 110 via the regional telco office 304 and to the local central office 306. In some embodiments, the multimedia players connect to the data center 102 via a satellite connection.

It has been found especially cost effective to utilize at least some wired communication connections such as DSL or cable modem to a wireless router placed at the gas station facility. In the embodiment illustrated in FIG. 3, a DSL wired connection is employed between the local central office 306 and the gas station 104. The display controllers located at the gas station are then wirelessly networked via a wired or wireless communication path to share a common incoming internet connection at the gas station to receive the incoming data file, compilation of data files, and other data.

In certain embodiments, the system 100 provides a comprehensive design for the broadcasting of data files to convenience stores and gas stations. Preferably, the communication connections between the data center 102 and the gas station 104 form a two-way or closed loop network to enhance data file security. Portions of the closed loop network may employ satellite, terrestrial, and wireless communications layers for purposes of narrowcasting specifically targeted data files to multimedia players in specific locations. In certain embodiments, the system 100 can broadcast multimedia content on a wireless network for display to gas pump users. In certain embodiments, the system, 100 utilizes a multicast capability using a terrestrial based network system In certain embodiments, the system 100 utilizes satellite broadcast of advertising information to players located on gas pumps.

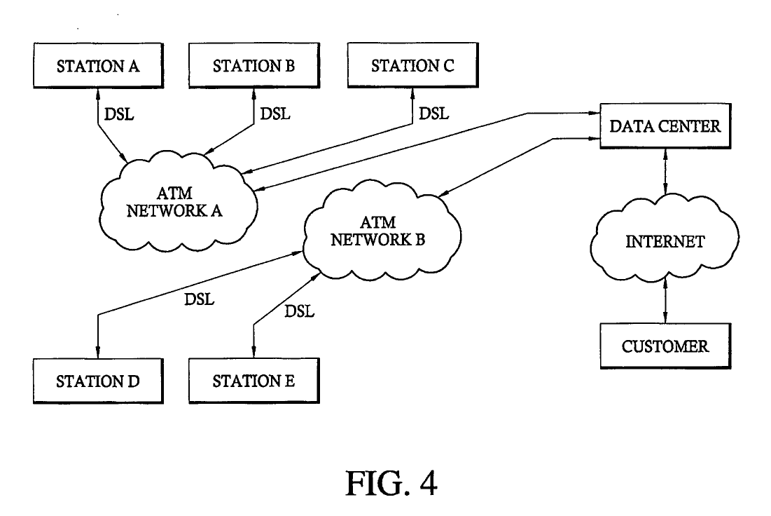

FIG. 3 illustrates one example of a wide area network 110 from FIG. 1. It will be understood that many other examples of wide area networks may be used. FIG. 4 is a block diagram of an embodiment of a system for assembling and distributing media to stations through two wide area networks (WAN) 402, 404. As shown in FIG. 4, the data center 102 communicates with the stations 104 via both WANs 402, 404. Of course, each network may employ different wired and wireless protocols and different combinations of wireless and wired protocols. Preferably each network is a private network to afford an enhanced level of security to the transmitted media as compared to a public network.

FIG. 5 is a block diagram of a pump island 504 that is wirelessly linked with an exemplary on-site local area network 508 to a convenience store 510 and configured to receive and display media and transmit related data with the convenience store. The on-site local area network 508 may be used at each of the convenience stores within the system 100. The data center 102 transmits the data files, information associated with the data files, and security codes over the WAN 110 and to the gas station and/or convenience store 104. A third party wireless access point 502 wirelessly transmits the data compilations and instructions to the media players 506 at the pump island 504.

Exemplary information or instructions associated with the data file, station, and gas pump include the following: Media filename, Country, State or Province, City, Postal Code, last 3 digits of Postal Code, Carwash, optional services, Start of Media filename Schedule, Start playing data file, Hour of start, Minute of start, Second of start, Day of start, Month of start, Year of start, Decade of start, Days to play media filename, Stop playing media filename, Hour, Minute, Second, Day, Month, Year, Decade, Category for General Information, Service Station Name, Service Station Owner Name, Primary Contact Name, Service Station Address, Service Station City, Service Station Sate or Province, Service Station Postal Code, Service Station Last 3 of Postal Code, Service Station Country, Service Station Hours, Is the station 24 hours?, Daily Hours, Service Station Phone, Service Station Fax, Service Station Mobile number, Category for Pump Info, How Many Self Serve Pumps, How Many Full, How Many Diesel, Pump make and model, Pump color, Category for C_Store Info, Is there an ATM, Do they serve alcohol, Other Service, Category for Service Info, Carwash, Additional Service, Start of Category, Country, City, State, Postal Code, Last three of Postal Code, Day of week separated by comma, Player Name, Loud time, and Quiet time.

The multimedia players 506 comprise player control software. The player control software controls and plays data files on display screens of the media players 506. The media players 506 may play media types including graphics (JPG, BMP, GIF, WMF, PNF, TIF, and the like) and audio/video (MPEG-1, MPEG-2, MPEG-3, MPEG-4, MPA, MPE, M3U, MPV2, AVI, MP3, MOV, QT, RA, RAM, WAV, MIDI, SWF, HTML, and the like).

The player control software plays data files according to the information received from the data center 102. This information may include a play list that specifies when the data files are to be played. The play list includes the sequence, type of the media, and data file to be played on the player 506. In addition to playing the data files based on the play list, the player may play the data files based on detailed information related to scheduling, media file content, and station location.

In certain embodiments, the player control software plays the data files based on criteria associated with the multimedia player 506. For example, the player control software may play two media content scenarios (Play “bookend” media while pump handle is down and play “ad” media content while pump handle is lifted), monitor frames per second on the multimedia player 506 (if frames per second is below a threshold, reboot Player), provide script support for text over image via XML (ability to lay text over a Graphics file on the player), display text for user input, adjust player volume, and play “black screen” according to schedule.

Attributes of the player 506 may include a unique XML Player Profile Definition file. In this way, each player 506 has its own unique, addressable identity. The Player Profile Definition for a given player 506 can be determined based upon an initial site survey and player 506 set up.

The player control software may further perform health monitoring. Health monitoring comprises, for example, monitoring player 506 module processes, detecting a stopped player 506 process, and rebooting the player 506. For example, the player control software monitors the number of frames being played per second and compares the frame rate to a minimum frame rate. In this way, if the performance of the player falls below the acceptable threshold, the player reboots so as to improve the performance and viewing of data file. For still images, the player control software controls the time duration of images displayed on the display in accordance with the instructions received from the data center 102. The player control software may further monitor receipt of data files and submission of report logs on received broadcast data.

The player control software operates as an unattended player device that is controlled remotely from the data center 102 to play media on a scheduled basis. The player control software accepts information sent to it, via for example, broadcast, multicast, or narrowcast, decode the data file and the instructions, and play the data file on a scheduled basis. The media player 306 interfaces with a nozzle switch on the gas pump device that acts as a trigger for signaling the software that the nozzle has been lifted from the unit to put fuel in a tank. This action enables the media player 306 and player control software to change the sequence of the information being played. It certain embodiments, the player control software logs information about the time and duration of both the pumping activity (fueling duration) and logs the specific display activity that was initiated during the time of the fueling. This information may be sent to the data center via the same communication path that the gas station received the media from the data center or different communication path.

The media player detects and initiates a change in the media content to be played based on specific instructions accompanying the data file. In certain embodiments, the data center uses a compressed file format to enhance data security and protect the data from unauthorized access. The player control software detects the presence of a new version of data once it is downloaded. This data may include data files (video, pictures, and/or sound) and/or instructions on how to play the current data files or data files received with the instructions. The decompressed data is store in the media player and accordingly play the data files on the prescribed basis.

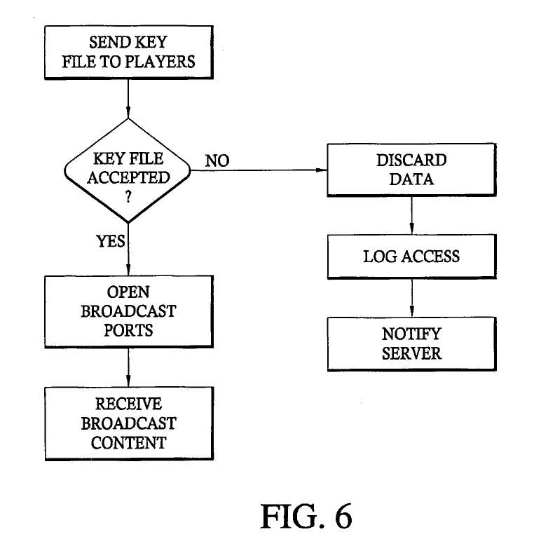

In certain embodiments, the player control software monitors all broadcast information received from the data center 102. The player control software recognizes when specific information needs to be stored for use by the multimedia player 506. In the event that a broadcast does not include specific information, for example a security code or key file, the player control software does not store the data file. As described with reference to FIG. 6, the incorporation of a key file with the received data file allows the player control software to verify the integrity of the data file. Preferably, the player control software discards data not intended for the media player so as to leave storage space for broadcasts intended for the media player.

The player control software maintains and transmits operational and status information to the data center 102. For example, the player control software keeps track of the detailed information about the gas pump activities and the data files played, logs data about the played data files, time stamps the logged data with the start and stop times of the specific data file, time stamps when the pump handle is lifted, and time stamps when the pump handle is returned to the holder. The player control software uploads the collected and logged data to the data center 102. In certain embodiments, this uploads can be on a scheduled (push) or requested (pull) basis.

In certain embodiments, the player control software varies the sound volume of the gas pump. For example, the player control software changes the sound volume according to a schedule based on time of day. It has been found that varying the volume based on different levels of ambient noise enhances a gas pump user's experience. For example, a gas station located beside an apartment building on a busy street can have louder volume during the day, when ambient traffic noise is heavy. At night, the volume is adjusted lower because the ambient sound is less.

The received data file is automatically played on the multimedia player 506 according to the instructions associated with the data file so that the data file is viewed by the gas pump customer. For example, when the gas pump is idle and the pump nozzle is hung up, the player control software makes the media player play static advertisement pictures which typically do not change frequently. When someone takes up the pump nozzle for fuelling, the gas pump detects such a status and notifies the player control software, whereupon the player control software controls the video displays to start playing dynamic data files which have been pre-stored in the memory of the media player. After the fuelling is finished and the pump nozzle is hung up, the gas pump notifies the player control software of this status, and the player control software stops playing dynamic data files and returns to playing static data files.

In certain embodiments, the appropriate data file is played at its associated play window or between an assigned start and end time and an assigned start and end date. For compilations, the data files may abut each other in a serial fashion, with a succeeding presentation beginning at the end of a preceding presentation. In other instances, the valid periods for display may overlap in several ways. For example, a periodic special promotion data file may supersede the standard data file.

Other on-site devices such as ATM machine, Lotto AD terminal, gas station POS/back office system, and associated third party switches may be included in the convenience store 104. To enhance media security, it is preferred that these on-site devices do not share the private communication network of the system 100.

FIG. 6 is a flow chart of one method for providing media security which may be performed by the system under the control of the player control software. The player control software monitors all broadcast information received from the data center 102. The player control software recognizes when specific information needs to be stored for use by the media player. In the event that a broadcast is not associated with specific information, recognized by the player control software for example a key file, the player control software may not store the data.

As described with reference to FIG. 6, the incorporation of a key file with the received data allows the player control software to verify the integrity of the data file. Preferably, the player control software discards data not intended for the media player associated with that player control software so as to leave storage space for broadcasts intended for the media player. The method begins at a block 602 when the data center 102 sends a key file and a data file to one or more media players. Each media player may be associated with a unique key file or pass code. In certain embodiments, the key file comprises a 64-bit pass code which enables the player control software to determine whether the data file associated with the key file originated from the data center. Alternatively, multiple media players may be associated with the same key file. For example, the media players at a specific location may share the same key file.

The data center 102 transmits the key file before, with, or after the data file is transmitted to the media player. Next at a decision block 604, the media player determines if the received key file is the correct key file for that media player. If the key file is correct, the media player opens its broadcast ports at block 606 to receive the data file at block 608.

Returning to decision block 604, the media player discards the data file at block 610 if the key file is not correct. The process continues to block 612 where the media player logs the attempt to access the media player. Next, at block 614 the media player notifies the data center of the attempt to access the media player. In one embodiment, the media player uploads the log containing the access attempt to the data center.

Embodiments of the system can perform communications with the data center at different places, transmit various information and update the data file content via wired network modes (such as ISDN, ADSL, or DDN dedicated line, etc.) or wireless modes (such as CDMA, GPRS, satellites, 802.11 wireless LAN, etc.). The above mentioned is the specific practice and the technical application principle of various invention embodiments. The scope of the invention is defined by the following claims, and any equivalents should be within the protective range of this invention.

What is claimed is:

1. A system for distributing advertising to a plurality of gas pumps via a combination of a first network and a second network, the system comprising:
a computer configured to store and transmit data over a first network;
a wireless access point remotely located from said computer and configured to receive the transmitted data and broadcast the received data over a second network via a wireless link; and
a plurality of gas pumps, each having a receiver for receiving the data transmitted by the wireless access point and configured to display at least some of the received data.

2. The system of claim 1, wherein the receiver is provided as an external enclosure including a viewable screen bolted onto an existing pump.

3. The system of claim 1, wherein at least one of the wireless access points transmits to the plurality of gas pumps.

4. The system of claim 1, wherein the wireless link is part of a local area network at a gas station.

5. The system of claim 1, wherein the plurality of gas pumps further comprise a transmitter configured to transmit data to the wireless access point.

6. The system of claim 1, wherein the first network includes a wireless link.

7. The system of claim 6, wherein the first network includes a satellite link.

8. The system of claim 1, wherein the first network includes a wired link.

9. The system of claim 8, wherein the first network is a terrestrial network.

10. A system for distributing advertising to a plurality of gas pumps via a combination of a wired link and a wireless link, the system comprising:
a computer configured to store and transmit data over a first network;
a wireless access point remotely located from said computer and configured to receive the transmitted data and broadcast the received data over a second network via a wireless link; and
a plurality of gas pumps, each having a receiver for receiving the data transmitted by the wireless access point and configured to display at least some of the received data.

11. The system of claim 10, wherein the receiver is provided as an external enclosure including a viewable screen bolted onto an existing pump.

12. The system of claim 10, wherein at least one of the wireless access points transmits to the plurality of gas pumps.

13. The system of claim 10, wherein the wireless link is part of a local area network at a gas station.

14. The system of claim 10, wherein the plurality of gas pumps further comprise a transmitter configured to transmit data to the wireless access point.

15. The system of claim 10, wherein the wireless link is not a satellite link.

16. A method of distributing advertising to a plurality of gas pumps comprising:
selecting one or more media files at a computer;
transmitting the media files to a wireless access point located remotely from the computer and over a first network;
receiving the media files at the wireless access point over the first network;
wirelessly transmitting the media files to a plurality of gas pumps over a second network;
storing the media files at each of the plurality of gas pumps; and
displaying at least one of said stored media files on a viewable screen coupled to at least one of the plurality of gas pumps.

17. The method of claim 16, wherein the first network is wired.

18. The method of claim 16, wherein the first network is one of either a wired network or a wireless network and the second network is the other network.

19. The method of claim 16, wherein the second network is wired.

20. The method of claim 16, wherein the second network is not satellite.
